(19) United States
(12) Patent Application Publication
(10) Pub. No.: US 2026/0285420 A1
(43) Pub. Date: Sep. 24, 2026

(54) TIRE COVER SECURING SYSTEM AND DEVICE

(71) Applicant: MUD DIGGER DESIGN CO. LLC, Maysville, NC (US)

(72) Inventor: Nathan DIGMAN, Maysville, NC (US)

(73) Assignee: MUD DIGGER DESIGN CO. LLC, Maysville, NC (US)

(21) Appl. No.: 19/577,302

(22) Filed: Mar. 24, 2026

Related U.S. Application Data
(60) Provisional application No. 63/776,514, filed on Mar. 24, 2025.

(51) Int. Cl. B62D 43/00; F16J 15/02

(52) U.S. Cl. CPC B62D 43/005; F16J 15/024

(57) ABSTRACT

Disclosed herein is a device for a tire cover securing system that includes a base, an O-ring, and a cap. Both the base and the cap have an opening. The O-ring is sized to fit the opening in the base. Also disclosed is a tire cover securing system that includes a base, an O-ring, a cover, and a cap. The base has an opening sized to fit the O-ring. The cap attaches to the cover and the base.

### PRIORITY CLAIM

This application claims the priority and benefit of U.S. Provisional Patent Application No. 63/776,514 filed on Mar. 24, 2025, which is incorporated by reference in its entirety.

### TECHNICAL FIELD

The disclosure relates generally to a tire cover securing system and device.

### BACKGROUND

The practice of carrying a spare tire has been a fundamental aspect of vehicle design since the early days of automobiles. Initially, spare tires were mounted on the sides of vehicles, often housed within fender wells or external compartments. As vehicle designs evolved, particularly with the advent of off-road and sport utility vehicles (SUVs), spare tires were increasingly relocated to the rear of the vehicle. This rear-mounted configuration became popular due to its convenience, ease of access, and ability to accommodate larger tire sizes without compromising interior storage space.

With the rear-mounted spare tire setup, manufacturers and consumers recognized the need to protect the spare tire from environmental elements such as sun exposure, dirt, and debris. As a result, tire covers became a common accessory, providing protection against UV rays, weather conditions, and general wear and tear. Tire covers also serve an aesthetic purpose, often featuring brand logos or custom designs to enhance vehicle appearance.

While tire covers offer significant protective benefits, they can also present practical challenges in modern vehicles equipped with advanced safety and convenience features. One such feature is the rear backup camera, which has become a standard component in contemporary vehicles to assist drivers with parking and reversing. Many rear-mounted cameras are positioned near or around the spare tire area, and a traditional tire cover can inadvertently obstruct or interfere with the camera's field of view. This obstruction reduces the effectiveness of the backup camera, potentially leading to safety concerns and driver inconvenience.

The need exists for a tire cover design that maintains the protective and aesthetic advantages of traditional covers while ensuring that backup cameras remain unobstructed. Addressing this issue is critical to enhancing vehicle safety, maintaining regulatory compliance, and improving driver confidence in modern driving conditions.

### SUMMARY

The disclosure herein relates generally to a tire cover securing system and device.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. The advantages of the present disclosure will become better understood with regard to the following description and accompanying drawings:

FIG. 1 illustrates an exploded view of a tire cover securing system and device.

FIG. 2 illustrates a perspective view of an O-ring that may be used in a cover securing system.

FIG. 3 illustrates a cross-sectional view O-ring that can be used in a cover securing system.

FIG. 4 illustrates a base that can be used in a cover securing system.

FIG. 5 illustrates a perspective view of an O-ring used in combination with a base that may be used in a cover securing system.

FIG. 6 illustrates an O-ring used in combination with a base that may be used in a cover securing system.

FIG. 7 illustrates a cap that can be used in a cover securing system.

FIG. 8 illustrates an attached tire cover securing system and device.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same or similar reference numbers are used throughout the drawings to refer to the same or similar parts. It is further noted that elements disclosed with respect to particular embodiments are not restricted to only those embodiments in which they are described. For example, an element described in reference to one embodiment or figure may be alternatively included in another embodiment or figure, regardless of whether or not those elements are shown or described in another embodiment or figure. In other words, elements in the figures may be interchangeable between various embodiments disclosed herein, whether shown or not.

In describing tire cover securing system and device, we may use directional terms such as proximal and distal to further orient elements or devices within the system. Distal elements will be positioned toward the outside end of the system when connected together. The outside or distal end of the system or devices is positioned towards the end that points away from a tire and/or a vehicle when attached. In this embodiment, the connectors are located away from the tire and therefore are oriented at a distal end. Alternately, the inside or proximal elements will be positioned towards the inside end of the system when connected. The inside or proximal end is positioned closer to the tire and/or the vehicle. In this embodiment, the inside or proximal position is located opposite of where the connectors are located. Regardless of where connectors are located, in different embodiments, the proximal and distal ends remain the same.

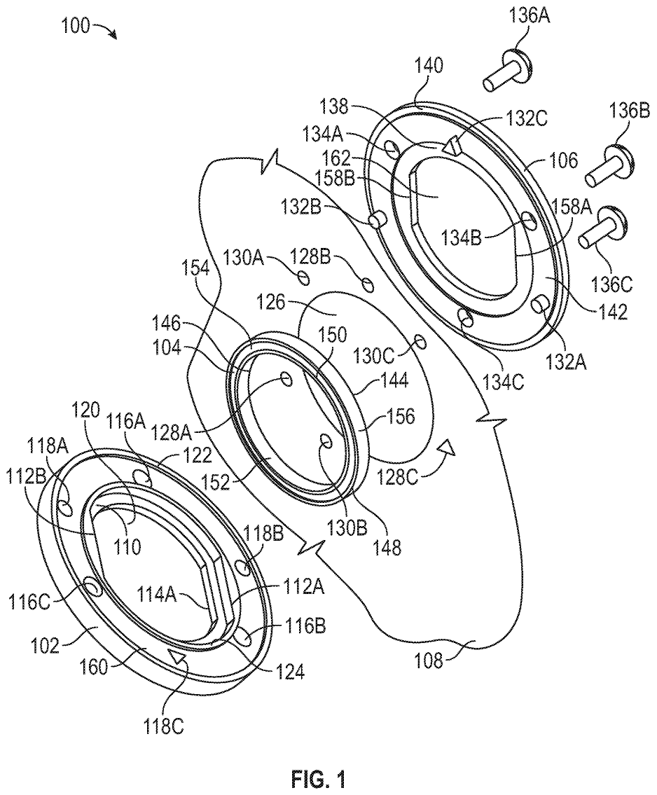

FIG. 1 illustrates an exploded view of a tire cover securing system 100 and devices. System 100 may include base 102, O-ring 104, cap 106, and cover 108. Base 102 may include connection apertures 116A-C and stud apertures 118A-C. Stud aperture 118A-C may not extend through base 102 such that stud apertures 118A-C may be pocket-sized to receive studs 132A-C. One or more of stud apertures 118A-C may be shaped differently to receive one or more of uniquely shaped studs 132A-C. For example, stud 132C may be triangle-shaped, and stud aperture 118C may be shaped to receive triangle-shaped stud 132C. This may allow a user to correctly orient the base 102 and cap 106. One or more of stud apertures 118A-C may be positioned closer to the center of the cap 106 than the others. For example, stud aperture 118C may be positioned closer to opening 120 than stud apertures 118A and 118B. Correspondingly, stud 132C may be positioned closer to opening 162 than studs 132A-B. Connection apertures 116A-C may be sized to fit connectors 136A-C. Connection apertures 116A-C may include a countersink on the outside of base 102. Base 102 may be a disk-shaped object that includes opening 120. A portion of opening 120 may be disposed through the center of base 102. Opening 120 may open towards the top or distal portion of base 102. Opening 120 may also open towards the bottom or proximal portion of base 102. The opening 120 towards the distal portion of base 102 may be larger than the opening 120 towards the bottom or proximal portion of base 102. The size discrepancy in opening 120 may create platform 110.

Further, opening 120 towards the distal and the proximal portions of base 102 may be rounded with flat edges 112A-B and flat edges 114A-B (114B is not seen due to perspective). Opening 120 may include flat edges 112A-B on the distal portion of opening 120 and flat edges 114A-B on the proximal portion of opening 120. Flat edges 112A-B may be larger than flat edges 114A-B. The space between flat edges 112A-B and 114A-B may be sized to fit the casing of a backup camera, such that the backup camera casing may fit through opening 120. The flat edges 112A-B may be sized to receive a flexible O-ring 104 such that O-ring 104 may contact flat edges 112A-B. Also, platform 110 may be sized to allow O-ring 104 to rest on platform 110. Flat edges 112A-B may bend the circular O-ring 104 to conform to the non-circular opening 120. As a result, flat edges 112A-B may help keep O-ring 104 in an effective position through friction and compliant mechanism forces.

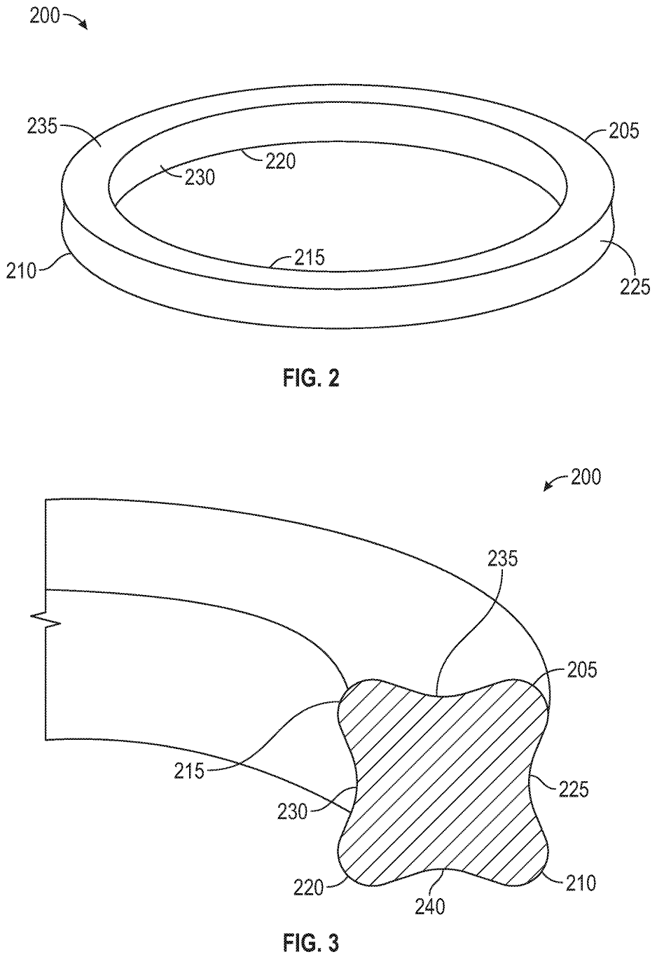

O-ring 102 may include four rounded peaks that may include a top or distal outside peak 144, a proximal outside peak 148, a distal inside peak 146, and a proximal inside peak 150. O-ring 200 may include four troughs, a distal trough not seen due to perspective but similar to 235 as seen in FIGS. 2 and 3. A proximal trough 154, an inside trough 152, and an outside trough 158 may also be included. System 100 may include cover 108 and may include opening 126. Cover 108 may also include stud apertures 128A-C and connection apertures 130A-C. Stud apertures 128A-C may be sized to receive studs 132A-C, respectively. Connection apertures 130A-C may be sized to receive connectors 136A-C, respectively.

System 100 may include cap 106. Cap 106 may include studs 132A-C. Studs 132 A-C may be attached to the bottom or proximal surface of middle ring 142. Studs 132A-C may be cylindrical or triangular in shape and may extend proximally. Alternatively, the studs 132A-C may be any geometric shape. Studs 132A-C may be sized to be received by stud apertures 118A-C disposed in base 102 and 128A-C disposed in cover 108. Cap 106 may also include outer ring 140 and inner ring 138. Both outer ring 140 and inner ring 138 may be inset distally within cap 106 such that outer ring 140 may be sized to receive outer ring 122 of base 102. Similarly, inner ring 138 may be sized to fit inner ring 124 of base 102. Middle ring 142 may extend outward proximally beyond that of inner ring 138 and outer ring 122. Middle ring 142 may be sized to be received by middle ring 160 of base 102. The interactions between rings 138 and 140 of Cap 106 and rings 122 and 124 of base 102 may aid in keeping cover 108, base 102, and O-ring 104 bound together.

Cap 106 may include opening 162 disposed through the center of cap 106. Opening 162 may be rounded with flat edges 158A-B. Opening 162 may be substantially similar to the proximal opening of base 102. In this way, flat edges 158A-B are sized substantially similarly to flat edges 114A-B. Substantially similar in this context means plus or minus 5%. Since base 102 is shaped to allow O-ring 104 to be placed on platform 110 in between flat edges 112A-B, this allows Cap 106 and base 102 to sandwich O-ring 104 and cover 108. O-ring 104, when sandwiched, may extend inwardly towards a center point beyond the inner edges of both the opening 120 of base 102 and the opening 162 of cap 106.

Cap 106 may also include Connection apertures 134A-C. Connection apertures 134A-C may be disposed through cap 106. Connection apertures 134A-C may be sized to receive connectors 136A-C, respectively. Connection apertures 134A-C may include a countersink on the outside portion of cap 106. Connectors may be comprised of rivets, bolts, screws, magnets, adhesives, clamps, or other connector devices known in the art. Accordingly, when connectors 136A-C are implemented, cap 106 may be secured to cover 108, O-ring 104, and base 102. Each part may work together to secure a cover to a tire and secure system 100 to a backup camera casing.

FIG. 2 illustrates a perspective view of O-ring 200 that may be used in a cover securing system and device. O-ring 200 may be made of a flexible material of any combination of natural or synthetic rubber, plastics, or combinations of materials. O-ring 200 may include four rounded peaks that may include a top or distal outside peak 225 a proximal outside peak 210, a distal inside peak 215, and a proximal inside peak 220. O-ring 200 may include four troughs: a distal trough 235, a proximal trough 240 (as seen in FIG. 3), an inside trough 230, and an outside trough 225. Using elements from FIG. 1, when O-ring 200 is installed proximal outside peak 210 may contact platform 110 and/or 112A-B flat edges. One or more distal peaks 205 and 215 may extend distally above inside ring 124 of base 102. Inside peaks 215 and 220 may extend inwardly beyond the inward edge of opening 120 of base 102 and opening 162 of cap 106. In this manner, one or more of peaks 215-220 and trough 230 may contact the casing of a backup camera that may be positioned between a spare tire.

FIG. 3 illustrates a cross-sectional view of O-ring 200 that can be used in a cover securing system and device. O-ring 200 may be in the shape of an “X,” which may provide a seal between the camera casing and the cover securing system. O-ring 200 may include four rounded peaks that may include a distal outside peak 225, a proximal outside peak 210, a distal inside peak 215, and a proximal inside peak 220. O-ring 200 may include four troughs: a distal trough 235, a proximal trough 240, an inside trough 230, and an outside trough 225. Using elements from FIG. 1, when O-ring 200 is installed proximal outside peak 210 may contact platform 110 and/or 112A-B flat edges. One or more distal peaks 205 and 215 may extend distally above inside ring 124 of base 102. Inside peaks 215 and 220 may extend inwardly beyond the inward edge of opening 120 of base 102 and opening 162 of cap 106. In this manner, one or more of peaks 215-220 and trough 230 may contact the casing of a backup camera that may be positioned between a spare tire.

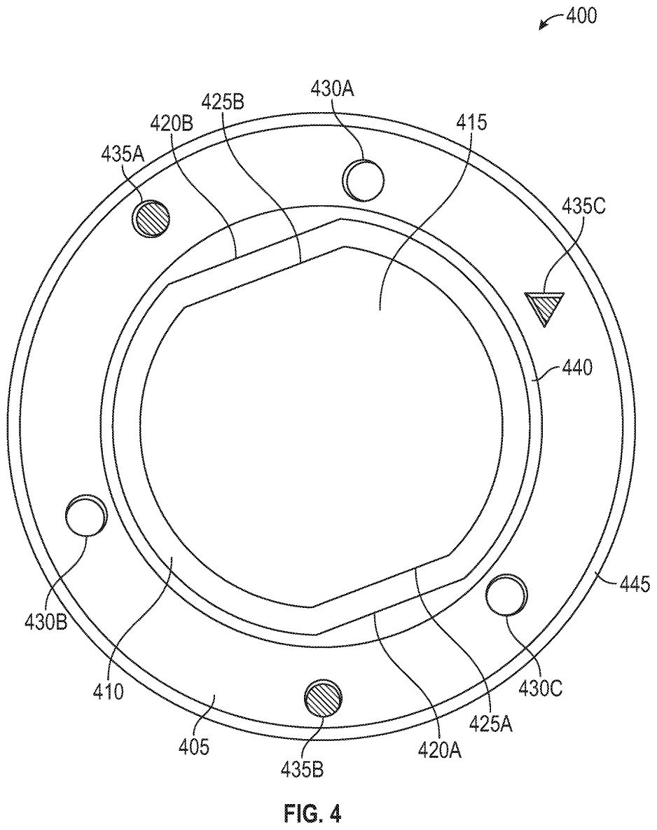

FIG. 4 illustrates base 400, which may be used in a cover securing system and device. In FIG. 4, base 400 is positioned with the distal side faced up. Base 400 may include connection apertures 430A-C and stud apertures 435A-C. Stud aperture 435A-C may not extend through base 400 such that stud apertures 435A-C may be pockets, sized to receive studs 132A-C(as depicted in FIG. 1). Connection apertures 430A-C may be sized to fit connectors 126A-136C (as depicted in FIG. 1). One or more of stud apertures 435A-C may be shaped differently to receive one or more of uniquely shaped studs (such as stud 132C as depicted in FIG. 1). For example, stud 132C may be triangle-shaped, and stud aperture 435C may be shaped to receive triangle-shaped stud 132C. This may allow a user to correctly orient the base 102 and cap 106. Base 400 may be a disk-shaped object that may include opening 415. A portion of opening 415 may be disposed through the center of base 400. Opening 415 may open towards the top or distal portion of base 400. Opening 415 may also open towards the bottom or proximal portion of base 400. The opening 415 towards a distal portion of base 400 may be larger than the opening 415 towards the bottom or proximal portion of base 400. The size discrepancy in opening 415 may create platform 410.

Further, opening 415 towards the distal and the proximal portions of base 400 may not be completely circular. Opening 415 may include flat edges 420A-B on the distal portion of opening 415 and flat edges 425A-B on the proximal portion of opening 415. Flat edges 420A-B may be larger than flat edges 425A-B. The space between flat edges 420A-B and 425A-B may be sized to fit the casing of a backup camera, such that the backup camera casing may fit through opening 415. The flat edges 420A-B may be sized to receive a flexible O-ring 104 (as depicted in FIG. 1) such that O-ring 104 may contact flat edges 415A-B. Also, platform 410 may be sized to allow O-ring 104 to rest on platform 410. Flat edges 420A-B may bend the circular O-ring 104 to conform to the non-circular opening 415. As a result, flat edges 420A-B may help keep O-ring 104 in an effective position through friction and compliant mechanism forces. These same forces may be used to attach to a backup camera casing.

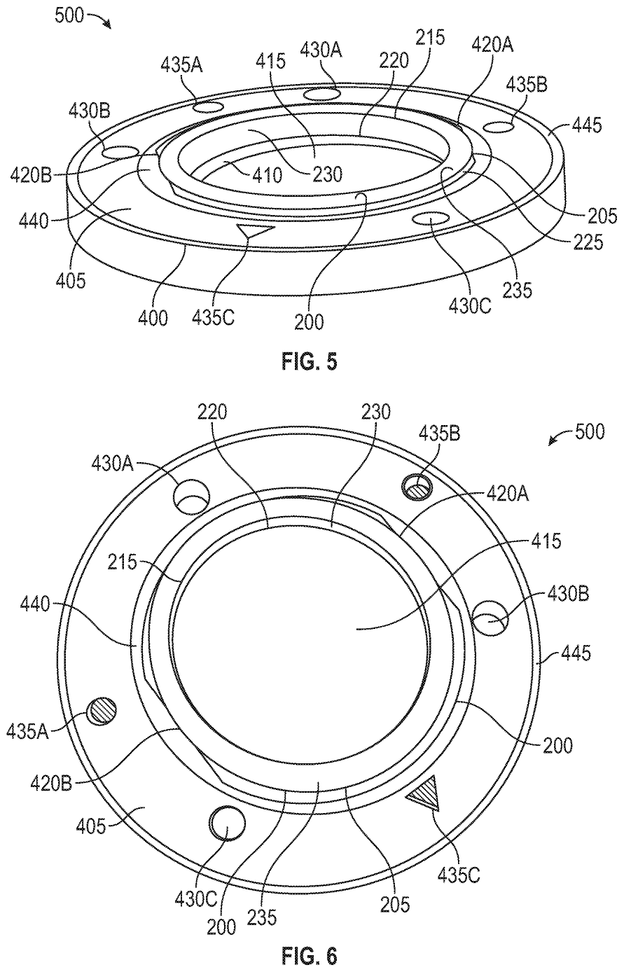

FIG. 5 illustrates a perspective view of a combination of an O-ring and a base that can be used in a cover securing system and device. Base 400 may include connection apertures 430A-C and stud apertures 435A-C. Stud aperture 435A-C may not extend through base 400 such that stud apertures 435A-C may be pockets sized to receive studs 132A-C(as depicted in FIG. 1). One or more of stud apertures 435A-C may be positioned closer to the center of the cap 415 than the others. For example, stud aperture 435C may be positioned closer to opening 415 than stud apertures 435A and 435B. Correspondingly, a stud such as 132C may be positioned closer to opening 162 than studs 132A-B, as depicted in FIG. 1.

Connection apertures 430A-C may be sized to fit connectors 126A-136C (as depicted in FIG. 1). Base 400 may be a disk-shaped object that may include opening 415. A portion of opening 415 may be disposed through the center of base 400. Opening 415 may open towards the top or distal portion of base 400. Opening 415 may also open towards the bottom or proximal portion of base 400 The opening 415 towards a distal portion of base 400 may be larger than the opening 415 towards the bottom or proximal portion of base 400. The size discrepancy in opening 415 may create platform 410.

Further, opening 415 towards the distal and the proximal portions of base 400 may not be completely circular. Opening 415 may include flat edges 420A-B on the distal portion of opening 415 and flat edges 425A-B on the proximal portion of opening 415. Flat edges 420A-B may be larger than flat edges 425A-B. The space between flat edges 420A-B and 425A-B may be sized to fit the casing of a backup camera, such that the backup camera casing may fit through opening 415. The flat edges 420A-B may be sized to receive a flexible O-ring 104 (as depicted in FIG. 1) such that O-ring 104 may contact flat edges 415A-B. Also, platform 410 may be sized to allow O-ring 104 to rest on platform 410. Flat edges 420A-B may bend the circular O-ring 104 to conform to the non-circular opening 415. As a result, flat edges 420A-B may help keep O-ring 104 in an effective position through friction and compliant mechanism forces. These same forces may be used to attach to a backup camera casing.

O-ring 200 may be made of a flexible material of any combination of natural or synthetic rubber, plastics, or combinations of materials. O-ring 200 may include four rounded peaks that may include a top or distal outside peak 225, a proximal outside peak 210, a distal inside peak 215, and a proximal inside peak 220 (as seen in FIGS. 2-3). O-ring 200 may include four troughs: a distal trough 235, a proximal trough 240, an inside trough 230, and an outside trough 225 (as seen in FIGS. 2-3). When O-ring 200 is installed proximal outside peak 210 may contact one or more of platform 410 and flat edges 420A-B (as depicted in FIG. 4). One or more distal peaks 205 and 215 may extend distally above inside ring 440 of base 400. Inside peaks 215 and 220 may extend inwardly beyond the inward edge of opening 415 of base 400 and opening 162 of cap 106 (as depicted in FIG. 1). In this manner, one or more of peaks 215-220 and trough 230 may contact the casing of a backup camera that may be positioned between a spare tire.

FIG. 6 illustrates a combination of an O-ring and a base that may be used in a cover securing system and device. Base 400 may include connection apertures 430A-C and stud apertures 435A-C. Stud aperture 435A-C may not extend through base 400 such that stud apertures 435A-C may be pockets sized to receive studs 132A-C(as depicted in FIG. 1). Connection apertures 430A-C may be sized to fit connectors 126A-136C (as depicted in FIG. 1). Base 400 may be a disk-shaped object that may include opening 415. A portion of opening 415 may be disposed through the center of base 400. Opening 415 may open towards the top or distal portion of base 400. Opening 415 may also open towards the bottom or proximal portion of base 400 The opening 415 towards a distal portion of base 400 may be larger than the opening 415 towards the bottom or proximal portion of base 400. The size discrepancy in opening 415 may create platform 410.

Further, opening 415 towards the distal and the proximal portions of base 400 may not be completely circular. Opening 415 may include flat edges 420A-B on the distal portion of opening 415 and flat edges 425A-B on the proximal portion of opening 415. Flat edges 420A-B may be larger than flat edges 425A-B. The space between flat edges 420A-B and 425A-B may be sized to fit the casing of a backup camera such that the backup camera casing may fit through opening 415. The flat edges 420A-B may be sized to receive a flexible O-ring 104 (as depicted in FIG. 1) such that O-ring 104 may contact flat edges 415A-B. Also, platform 410 may be sized to allow O-ring 104 to rest on platform 410. Flat edges 420A-B may bend the circular O-ring 104 to conform to the non-circular opening 415. As a result, flat edges 420A-B may help keep O-ring 104 in an effective position through friction and compliant mechanism forces. These same forces may be used to attach to a backup camera casing.

O-ring 200 may be made of a flexible material of any combination of natural or synthetic rubber, plastics, or combinations of materials. O-ring 200 may include four rounded peaks that may include a top or distal outside peak 225, a proximal outside peak 210, a distal inside peak 215, and a proximal inside peak 220 (as seen in FIGS. 2-3). O-ring 200 may include four troughs: a distal trough 235, a proximal trough 240, an inside trough 230, and an outside trough 225 (as seen in FIGS. 2-3). When O-ring 200 is installed proximal outside peak 210 may contact one or more of platform 410 and flat edges 420A-B (as depicted in FIG. 4). One or more distal peaks 205 and 215 may extend distally above inside ring 440 of base 400. Inside peaks 215 and 220 may extend inwardly beyond the inward edge of opening 415 of base 400 and opening 162 of cap 106 (as depicted in FIG. 1). In this manner, one or more of peaks 215-220 and trough 230 may contact the casing of a backup camera that may be positioned between a spare tire.

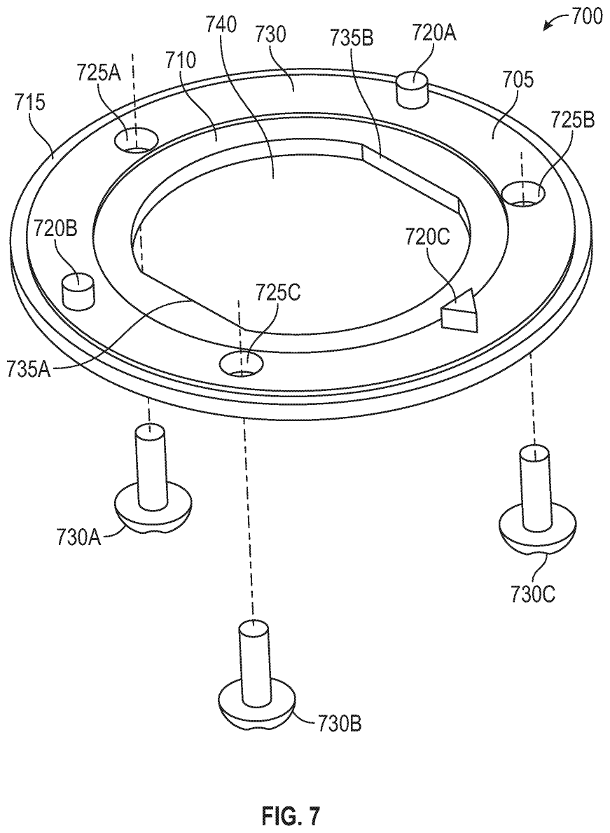

FIG. 7 illustrates cap 700, which may be used in a cover securing system and device. Cap 700 may include studs 720A-C. Studs 720A-C may be attached to the bottom or proximal surface of middle ring 142. Studs 720A-C may be cylindrical or triangular in shape and may extend proximally. Alternatively, the studs 720A-C may be any geometric shape. One or more of studs 720A-C may be positioned closer to the center of the cap 700 than the others. For example, stud aperture 720C may be positioned closer to opening 740 than stud apertures 720A and 720B. Opening 740 may be disposed through the center of cap 700. Opening 740 may be rounded with flat edges 735A-B. Opening 740 may be sized substantially similar to the proximal opening of base 400 (as seen in FIGS. 4-6). In this way, flat edges 735A-B are sized substantially similar to flat edges 425A-B. Substantially similar in this context means plus or minus 5%. Since base 400 is shaped to allow O-ring 200 (as seen in FIGS. 2-3) to be placed on platform 410 in between flat edges 420A-B, this allows Cap 700 and base 400 to sandwich O-ring 200 and cover 108. O-ring 200, when sandwiched, may extend towards a center point beyond the inner edges of both the opening 415 of base 400 and the opening 740 of cap 700.

Cap 700 may also include Connection apertures 725A-C. Connection apertures 725A-C may be disposed through cap 700. Connection apertures 725A-C may be sized to receive connectors 730A-C, respectively. Connectors 730A-C may be comprised of rivets, bolts, screws, magnets, adhesives, clamps, or other connector devices known in the art. Accordingly, when connectors 730A-C are implemented, cap 700 may be secured to cover 108, O-ring 200, and base 400 (as seen in FIG. 1). Each part may work together to secure a tire cover and the secure system to a backup camera casing.

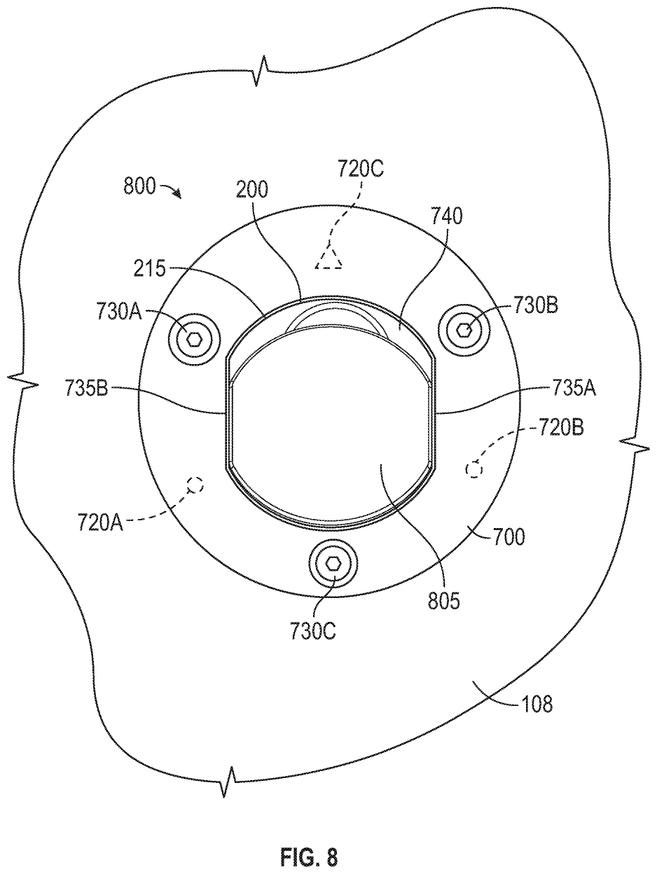

FIG. 8 illustrates an attached tire cover securing system 800. System 800 may include System 800 may include base 400 (as depicted in FIGS. 4-6 but not seen in FIG. 8 due to perspective), O-ring 200 (as seen in FIGS. 2-3 and 5-6), cap 700 (as seen in FIG. 7, and cover 108 (as seen in FIG. 1). Base 400 may include connection apertures 430A-C and stud apertures 435A-C. Stud aperture 435A-C may not extend through base 400 such that stud apertures 435A-C may be pockets, sized to receive studs 720A-C(as depicted in FIG. 7). Connection apertures 430A-C may be sized to fit connectors 730A-C (as depicted in FIG. 7). Base 400 may be a disk-shaped object that may include opening 415. A portion of opening 415 may be disposed through the center of base 400. Opening 415 may open towards the top or distal portion of base 400. Opening 415 may also open towards the bottom or proximal portion of base 400. The opening 415 towards a distal portion of base 400 may be larger than the opening 415 towards the bottom or proximal portion of base 400. The size discrepancy in opening 415 may create platform 410.

Further, opening 415 towards the distal and the proximal portions of base 400 may not be completely circular. Opening 415 may include flat edges 420A-B on the distal portion of opening 415 and flat edges 425A-B on the proximal portion of opening 415. Flat edges 420A-B may be larger than flat edges 425A-B. The space between flat edges 420A-B and 425A-B may be sized to fit the casing of a backup camera, such that the backup camera casing may fit through opening 415. The flat edges 420A-B may be sized to receive a flexible O-ring 200 (as depicted in FIGS. 2-3 and 5-6) such that O-ring 200 may contact flat edges 415A-B. Also, platform 410 may be sized to allow O-ring 200 to rest on platform 410. Flat edges 420A-B may bend the circular O-ring 200 to conform to the non-circular opening 415. As a result, flat edges 420A-B may help keep O-ring 200 in an effective position through friction and compliant mechanism forces. These same forces may be used to attach to a backup camera casing 805.

O-ring 200 may be made of a flexible material of any combination of natural or synthetic rubber, plastics, or combinations of materials. O-ring 200 may include four rounded peaks that may include a top or distal outside peak 225, a proximal outside peak 210, a distal inside peak 215, and a proximal inside peak 220. O-ring 200 may include four troughs: a distal trough 235, a proximal trough 240 (as seen in FIG. 3), an inside trough 230, and an outside trough 225. O-ring 200 is installed proximal outside peaks 210 and 210 and may contact one or more of platform 410 and 420A-B flat edges. One or more distal peaks 205 and 215 may extend distally above inside ring 124 of base 102. Inside peaks 215 and 220 may extend inwardly beyond the inward edge of opening 120 of base 102 and opening 162 of cap 106. In this manner, one or more of peaks 215-220 and trough 230 may contact the backup camera casing 805 that may be positioned between a spare tire. Outside distal peak 215 is seen in FIG. 8 while the remaining troughs 225, 230, 235, 240, and peaks 205, 210, and 220 remain unseen due to perspective.

System 800 may also include cap 700. Cap 700 may include opening 740 disposed through the center of cap 700. Opening 740 may be rounded with flat edges 735A-B. Opening 740 may be sized substantially similar to the proximal opening of base 400 (as seen in FIGS. 4-6). In this way, flat edges 735A-B are sized substantially similar to flat edges 425A-B. Substantially similar in this context means plus or minus 5%. Since base 400 is shaped to allow O-ring 200 (as seen in FIGS. 2-3 and 5-6) to be placed on platform 410 in between flat edges 420A-B, this allows Cap 700 and base 400 to sandwich O-ring 200 and cover 108. O-ring 200, when sandwiched, may extend inwardly towards a center point beyond the inner edges of both the opening 415 of base 400 and the opening 740 of cap 700. Many elements listed are not seen in FIG. 8 due to perspective, but other elements may be depicted in FIG. 7.

Cap 700 may also include Connection apertures 725A-C. Connection apertures 725A-C may be disposed through cap 700. Connection apertures 725A-C may be sized to receive connectors 730A-C, respectively. Connectors 730A-C may be comprised of rivets, bolts, screws, magnets, adhesives, clamps, or other connector devices known in the art. Accordingly, when connectors 730A-C are implemented, cap 700 may be secured to cover 108 (as seen in FIG. 1), O-ring 200, and base 400. Each part may work together to secure a cover to a tire and the secure system to a backup camera casing 805. Many elements described in FIG. 8 may not be depicted due to perspective, but reference to FIGS. 1-7 may depict elements missing from view and are to be included by reference.

While various embodiments of the present disclosure have been described above, it should be understood that they have been presented by way of example only, and not by limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A device for a tire cover securing system comprising:
a base comprising
an opening;
an O-ring sized to be placed in the opening of the base; and
a cap connecting to the base and the cover comprising:
an opening.

2. The device for a tire cover securing system of claim 1, wherein the base comprises:
a platform sized to seat the O-ring.

3. The device for a tire cover securing system of claim 1, wherein the base opening comprises:
one or more flat edges.

4. The device for a tire cover securing system of claim 1, wherein the base opening is non-circular.

5. The device for a tire cover securing system of claim 4, wherein the O-ring comprises:
one or more troughs and
one or more peaks.

6. The device for a tire cover securing system of claim 5, wherein the O-ring is deformed when placed in the base opening.

7. The device for a tire cover securing system of claim 6, wherein the O-ring extends inwardly beyond the inward portion of the base opening.

8. The device for a tire cover securing system of claim 7, wherein when the O-ring is seated in the base, one of the one or more peaks extends inwardly beyond the inner edge of the opening of the base such that the peak contacts a backup camera casing.

9. The device for a tire cover securing system of claim 1, wherein the base comprises:
one or more stud apertures.

10. The device for a tire cover securing system of claim 9, where one of the one or more stud apertures is shaped differently.

11. A tire cover securing system comprising:
a base comprising
an opening;
an O-ring sized to be placed in the opening of the base
a cover comprising:
an opening; and
a cap connecting to the base and the cover comprising:
an opening.

12. The tire cover securing system of claim 11, wherein the base comprises:
a platform sized to seat the O-ring.

13. The tire cover securing system of claim 11, wherein the base opening comprises:
one or more flat edges.

14. The tire cover securing system of claim 11, wherein the base opening is non-circular.

15. The tire cover securing system of claim 14, wherein the O-ring comprises:
one or more troughs and one or more peaks.

16. The tire cover securing system of claim 15, wherein the O-ring is deformed when placed in the base opening.

17. The tire cover securing system of claim 16, wherein the O-ring extends inwardly beyond the inward portion of the base opening.

18. The tire cover securing system of claim 17, wherein when the O-ring is seated in the base, one of the one or more peaks extends inwardly beyond the inner edge of the opening of the base such that the peak contacts a backup camera casing.

19. The tire cover securing system of claim 11, wherein the base comprises:
one or more stud apertures.

20. The tire cover securing system of claim 19, where one of the one or more stud apertures is shaped differently.
